(19) United States
(12) Patent Application Publication
(10) Pub. No.: US 2022/0195202 A1
(43) Pub. Date: Jun. 23, 2022

(54) SURFACE MODIFICATION METHOD FOR INORGANIC PARTICLES, METHOD FOR PRODUCING DISPERSION LIQUID, AND DISPERSION LIQUID

(71) Applicant: SUMITOMO OSAKA CEMENT CO., LTD., TOKYO (JP)

(72) Inventors: Tomomi ITO, TOKYO (JP); Kenji HARADA, TOKYO (JP); Takeshi OTSUKA, TOKYO (JP)

(73) Assignee: SUMITOMO OSAKA CEMENT CO., LTD., TOKYO (JP)

(21) Appl. No.: 17/599,562

(22) PCT Filed: Mar. 24, 2020
(86) PCT No.: PCT/JP2020/012972

§ 371 Date: Sep. 29, 2021

(30) Foreign Application Priority Data
Mar. 29, 2019 (JP) 2019-066855

(51) Int. Cl. C09C 3/12; C09C 1/00; C08K 9/06

(52) U.S. Cl. CPC C09C 3/12; C09C 1/00; C08K 9/06; C08K 2201/011; C01P 2004/62; C08K 2201/005; C01P 2004/64

(57) ABSTRACT

Provided is a method for surface-modifying inorganic particles having a mixing step of mixing at least a surface-modifying material and the inorganic particles to obtain a liquid mixture and a dispersion step of dispersing the inorganic particles in the liquid mixture, in which a content of the inorganic particles in the liquid mixture is 10% by mass or more and 49% by mass or less, and a total content of the surface-modifying material and the inorganic particles in the liquid mixture is 65% by mass or more and 98% by mass or less.

### TECHNICAL FIELD

The present invention relates to a method for surface-modifying inorganic particles, a method for producing a dispersion liquid, and a dispersion liquid.

Priority is claimed on Japanese Patent Application No. 2019-066855, filed in Japan on Mar. 29, 2019, the content of which is incorporated herein by reference.

### BACKGROUND ART

Inorganic particles are capable of imparting a variety of performances such as a refractive index adjustment effect and a heat ray-shielding function to components, members, or materials. Therefore, inorganic particles are being used in a variety of technical fields such as cosmetics, resin products, or optical components.

When not modified, inorganic particles are usually hydrophilic since hydroxyl groups are generally present on the surfaces of the inorganic particles. Therefore, in the case of adding inorganic particles to a hydrophobic material, the surfaces of the inorganic particles are modified to be hydrophobic with a surface modifier such as a silane coupling agent.

For example, Patent Literature 1 proposes a pigment for a cosmetic that has a surface coated with a specific silane coupling agent such as n-octyltriethoxysilane, feels moist and light while remaining highly water-repellent when blended with cosmetics, and has a favorable property of being attached to the skin.

In addition, Patent Literature 2 proposes a transparent dispersion liquid of an inorganic oxide containing inorganic oxide particles having surfaces modified with a surface-modifying agent having one or more reactive functional groups and having dispersed-particle diameters of 1 nm or more and 20 nm or less.

### CITATION LIST

### Patent Literature

[Patent Literature No. 1] Japanese Laid-Open Patent Publication No. 2001-181136
[Patent Literature No. 2] Pamphlet of International Publication No. WO 2007/049573

### SUMMARY OF INVENTION

### Technical Problem

Incidentally, in a case where inorganic particles are surface-modified with a surface-modifying material in a liquid phase, it is common to mix not only the inorganic particles and the surface-modifying material but also a dispersion medium to obtain a liquid mixture and disperse this liquid mixture using a disperser. When the inorganic particles which have been surface-modified by such a method are mixed with a highly hydrophobic material, the inorganic particles cannot be sufficiently dispersed in the material and agglomerate, which has resulted in a problem of the occurrence of turbidity such as white turbidity in the highly hydrophobic material.

The present invention has been made in order to solve the above-described problem, and an object of the present invention is to provide a method for surface-modifying inorganic particles that is intended to obtain inorganic particles in which agglomeration is suppressed even when mixed with a highly hydrophobic material and the occurrence of turbidity such as white turbidity is prevented, a method for producing a dispersion liquid, and a dispersion liquid.

### Solution to Problem

In order to solve the above-described problem, as a first aspect of the present invention,

there is provided a method for surface-modifying inorganic particles, having a mixing step of mixing at least a surface-modifying material and the inorganic particles to obtain a liquid mixture and

a dispersion step of dispersing the inorganic particles in the liquid mixture,

in which a content of the inorganic particles in the liquid mixture is 10% by mass or more and 49% by mass or less, and a total content of the surface-modifying material and the inorganic particles in the liquid mixture is 65% by mass or more and 98% by mass or less.

The method of the first aspect of the present invention preferably includes characteristics to be described below. The characteristics to be described below may be a single characteristic or a combination of two or more characteristics.

The method for surface-modifying inorganic particles further has a hydrolysis step of mixing at least the surface-modifying material and water before the mixing step to obtain a hydrolyzed liquid containing a hydrolyzed surface-modifying material,

in which the mixing step may be a step of mixing the hydrolyzed liquid containing the hydrolyzed surface-modifying material and the inorganic particles to obtain the liquid mixture.

An amount of water that is added to the hydrolyzed liquid may be 0.5 mol or more and 5 mol or less with respect to 1 mol of the surface-modifying material.

In addition, in order to solve the above-described problem, as a second aspect of the present invention, there is provided a method for producing a dispersion liquid, having a mixing step of mixing a surface-modifying material and inorganic particles to obtain a liquid mixture and

a dispersion step of dispersing the inorganic particles in the liquid mixture to obtain the dispersion liquid in which the inorganic particles are dispersed,

in which a content of the inorganic particles in the liquid mixture is 10% by mass or more and 49% by mass or less, and a total content of the surface-modifying material and the inorganic particles in the liquid mixture is 65% by mass or more and 98% by mass or less.

In addition, in order to solve the above-described problem, as a third aspect of the present invention, there is provided a dispersion liquid containing inorganic particles and one or more surface-modifying materials that are at least partially attached to the inorganic particles,

in which a content of the inorganic particles is 10% by mass or more and 49% by mass or less, and

a total content of the surface-modifying material and the inorganic particles is 65% by mass or more and 98% by mass or less.

The dispersion liquid of the third aspect of the present invention preferably includes characteristics to be described below. The characteristics to be described below may be a single characteristic or a combination of two or more characteristics.

When a volume-based 90% particle diameter of the inorganic particles is represented by D90, and a volume-based 50% particle diameter of the inorganic particles is represented by D50, D90/D50 may be 1.0 or more and 3.0 or less.

An average primary particle diameter of the inorganic particles may be 3 nm or more and 200 nm or less.

### Advantageous Effects of Invention

According to the present invention, it is possible to provide a method for surface-modifying inorganic particles that is intended to obtain inorganic particles in which agglomeration is suppressed even when mixed with a highly hydrophobic material and the occurrence of turbidity such as white turbidity is prevented, a method for producing a dispersion liquid, and a dispersion liquid.

### DESCRIPTION OF EMBODIMENTS

Hereinafter, an example of a preferable embodiment of the present invention will be described in detail.

The present embodiment is simply a specific description for better understanding of the gist of the invention and does not limit the present invention unless particularly otherwise specified. Amounts, numbers, kinds, ratios, configurations, and the like can be omitted, added, substituted, or changed without departing from the gist of the present invention.

<1. Present Inventors' Idea>

First, prior to the detailed description of the present invention, an idea by the present inventors that leads to the present invention will be described.

As described above, in a case where inorganic particles are surface-modified with a surface-modifying material in a liquid phase, it is common to mix not only the inorganic particles and the surface-modifying material but also a dispersion medium to obtain a liquid mixture and then disperse this liquid mixture using a disperser. Here, when such surface-modified inorganic particles are mixed with a highly hydrophobic material, the inorganic particles cannot be sufficiently dispersed in the material and agglomerate, which results in a problem of the occurrence of turbidity such as white turbidity in the highly hydrophobic material. In such a case, the inorganic particles that are added do not sufficiently exhibit intended performance.

The dispersion medium is usually added for the purpose of uniformly dispersing the inorganic particles and uniformly modifying the surfaces of the inorganic particles with the surface-modifying material. In the related art, it has been considered that, in the case of not using a dispersion medium, the viscosity of the dispersion liquid increases, and consequently, the surface-modifying material is not sufficiently attached to the surfaces of the inorganic particles. Surprisingly, the present inventors found that it is possible to uniformly disperse inorganic particles in a dispersion liquid to be obtained and uniformly modify the inorganic particles with a surface-modifying material by directly dispersing the inorganic particles in a high concentration of the surface-modifying material while using no dispersion medium or only a small amount of a dispersion medium that has been regarded as essential in the related art as described above.

Furthermore, the present inventors found that, when the dispersion liquid that is obtained as described above is mixed with a highly hydrophobic material, the inorganic particles can be dispersed in the material with no agglomeration and the occurrence of turbidity is suppressed and completed the present invention.

The reason for the fact that, in the case of using a large amount of the dispersion medium during the dispersion, the inorganic particles are not dispersed in the highly hydrophobic material and turbidity occurs at the time of mixing the dispersion liquid with the highly hydrophobic material is not clear. However, it is conceivable that the presence of the dispersion medium makes the surface-modifying material dilute in the vicinities of the inorganic particles, consequently, the reactivity of the surface-modifying material with respect to the inorganic particles deteriorates, and a sufficient amount of the surface-modifying material is not attached to the inorganic particles. In addition, it is conceivable that, in the case of using a large amount of a hydrophobic solvent as the dispersion medium during the dispersion, the inorganic particles originally having a hydroxyl group on the surface are not sufficiently dispersed. In addition, in the case of using a large amount of a hydrophilic solvent as the dispersion medium during the dispersion, the miscibility between the hydrophilic solvent that is contained in the dispersion liquid and the highly hydrophobic material is not sufficient.

In addition, it is also conceivable to attach the surface-modifying material to the surfaces of the inorganic particles by a dry method with a Henschel mixer, a spray dryer, or the like. However, in this case, there is a tendency that the inorganic particles agglomerate and the surface-modifying material is not uniformly attached to the surface of the inorganic particles. Furthermore, it is considered that, in the case of modifying the surfaces by a dry method, it is difficult to use a sufficient amount of the surface-modifying material. As a result, at the time of mixing the inorganic particles with the highly hydrophobic material, the inorganic particles are not sufficiently dispersed in the material, and turbidity occurs.

<2. Method for Surface-Modifying Inorganic Particles and Method for Producing Dispersion Liquid>

Next, a preferable example of a method for surface-modifying inorganic particles and a method for producing a dispersion liquid according to the present embodiment will be described. The method for surface-modifying inorganic particles may also be considered as a method for producing a dispersion liquid.

The method for surface-modifying inorganic particles according to the present embodiment that has been conceived by the present inventors through the above-described studies has a step (mixing step) of mixing a surface-modifying material and inorganic particles to obtain a liquid mixture and a step (dispersion step) of dispersing the inorganic particles in the liquid mixture. The content of the inorganic particles in the liquid mixture is 10% by mass or more and 49% by mass or less, and the total content of the surface-modifying material and the inorganic particles in the liquid mixture is 65% by mass or more and 98% by mass or less.

The total content of the surface-modifying material and the inorganic particles does not include an alcohol that is generated by the hydrolysis of the surface-modifying material to be described below. That is, the total content of the surface-modifying material and the inorganic particles may mean the total amount of the surface-modifying material that is not hydrolyzed, the surface-modifying material that has been hydrolyzed, and the inorganic particles. It is needless to say that the total content is a value including the content of the inorganic particles attached to the surface-modifying material.

In addition, the method for producing a dispersion liquid according to the present embodiment has a step (mixing step) of mixing a surface-modifying material and inorganic particles to obtain a liquid mixture and a step (dispersion step) of dispersing the inorganic particles in the liquid mixture to obtain a dispersion liquid in which inorganic particles are dispersed. In the liquid mixture, the content of the inorganic particles in the liquid mixture is 10% by mass or more and 49% by mass or less, and the total content of the surface-modifying material and the inorganic particles in the liquid mixture is 65% by mass or more and 98% by mass or less.

In the present embodiment, prior to each of the above-described steps, a step (hydrolysis step) of mixing the surface-modifying material and water to obtain a hydrolyzed liquid containing a hydrolyzed surface-modifying material is preferably provided.

Hereinafter, each step will be described in detail.

(2.1 Hydrolysis Step)

In the present step, the surface-modifying material and water are mixed to obtain a hydrolyzed liquid containing a hydrolyzed surface-modifying material. The use of a liquid mixture in which at least a part of the surface-modifying material is hydrolyzed in advance as described above makes it easy for the surface-modifying material to be attached to the inorganic particles in the dispersion step to be described below.

Such a surface-modifying material can be arbitrarily selected, and a surface-modifying material having a reactive functional group, for example, at least one functional group selected from the group of an alkenyl group, a H—Si group, and an alkoxy group is preferably used. Particularly, a surface-modifying material having an alkoxy group can be hydrolyzed by a reaction with water and is thus preferably used in the present embodiment.

As an example of the alkenyl group, for example, a linear or branched alkenyl group having 2 to 5 carbon atoms can be used, and, specifically, preferable examples thereof include a vinyl group, a 2-propenyl group, a prop-2-en-1-yl group, and the like.

Preferable examples of the alkoxy group include a linear or branched alkoxy group having 1 to 5 carbon atoms is exemplified, and, specifically, a methoxy group, an ethoxy group, an n-propoxy group, an isopropoxy group, a butoxy group, and the like.

Preferable examples of the surface-modifying material having at least one functional group selected from the group of the alkenyl group, a H—Si group, and the alkoxy group include a silane compound, a silicone compound, and a carbon-carbon unsaturated bond-containing fatty acid below. One of these can be used singly or two or more thereof can be used in combination.

Examples of the silane compound include silane compounds including an alkyl group and an alkoxy group such as methyltrimethoxysilane, methyltriethoxysilane, methyltripropoxysilane, ethyltrimethoxysilane, ethyltriethoxysilane, and ethyltripropoxysilane, isobutyltrimethoxysilane, methylphenyldimethoxysilane and methylphenyldiethoxysilane, silane compounds including an alkenyl group and an alkoxy group such as vinyltrimethoxysilane, methacryloxypropyltrimethoxysilane and acryloxipropyltrimethoxysilane, silane compounds including a H—Si group and an alkoxy group such as diethoxymonomethylsilane, monoethoxydimethylsilane, diphenylmonomethoxysilane and diphenylmonoethoxysilane, silane compounds including other alkoxy groups such as phenyltrimethoxysilane, silane compounds including a H—Si group such as dimethylchlorosilane, methyldichlorosilane, diethylchlorosilane, ethyldichlorosilane, methylphenylchlorosilane, diphenylchlorosilane, phenyldichlorosilane, trimethoxysilane, dimethoxysilane, monomethoxysilane and triethoxysilane, and the like.

Examples of the silicone compound include methyl phenyl silicone, dimethyl silicone, silicone compounds having a H—Si group such as methyl hydrogen silicone, methyl phenyl hydrogen silicone, and diphenyl hydrogen silicone, and silicone compounds having an alkoxy group such as alkoxy both-terminal phenyl silicone, alkoxy both-terminal methyl phenyl silicone, alkoxy group-containing methyl phenyl silicone, alkoxy group-containing dimethyl silicone, alkoxy one-terminal trimethyl one-terminal (methyl group one-terminal) dimethyl silicone, and alkoxy group-containing phenyl silicone.

The silicone compound may be a monomer, may be an oligomer, or may be a resin (polymer). As the silicone compound, a monomer or an oligomer is preferably used since surface modification is easy.

Examples of the carbon-carbon unsaturated bond-containing fatty acid include a methacrylic acid, an acrylic acid, and the like.

One of these compounds can be used singly or two or more thereof can be used in combination.

Among the above-described surface-modifying materials, the surface-modifying material is preferably a silane compound including an alkyl group and an alkoxy group or preferably contains this compound from the viewpoint of a low viscosity and easy dispersion of the inorganic particles in the dispersion step to be described below.

The number of alkoxy groups in such a silane compound including an alkyl group and an alkoxy group may be preferably 1 or more and 3 or less, and the number of alkoxy groups is more preferably 3. The number of alkoxy groups may be 1 or 2 as necessary. The number of carbon atoms in the alkoxy group can be arbitrarily selected, but is preferably 1 or more and 5 or less. The number of carbon atoms may be 1 or more and 3 or less or 2 or more and 4 or less.

The number of alkyl groups in the silane compound including an alkyl group and an alkoxy group is preferably 1 or more and 3 or less and more preferably 1. The number of alkyl groups may be 2 or 3 as necessary. The number of carbon atoms in the alkyl group is preferably 1 or more and 5 or less, more preferably 1 or more and 3 or less, and still more preferably 1 or more and 2 or less. The total number of the alkoxy groups and the alkyl groups is preferably 2 or more and 4 or less and more preferably 4.

Examples of the silane compound as such a surface-modifying material include methyltrimethoxysilane, methyltriethoxysilane, methyltripropoxysilane, ethyltrimethoxysilane, ethyltriethoxysilane, and ethyltripropoxysilane, and one or more selected from the group consisting of these compounds can be preferably contained.

The viscosity of the surface-modifying material at 25° C. can be selected as necessary and is preferably, for example, 50 mPa s or less.

When the viscosity of the surface-modifying material is 50 mPa s or less, it is possible to disperse the inorganic particles in the surface-modifying material without containing a large amount of the dispersion medium. The viscosity mentioned herein refers to the viscosity that is measured according to Z 8803: 2011.

In addition, the content of the surface-modifying material in the hydrolyzed liquid is not particularly limited. The content of the surface-modifying material in the hydrolyzed liquid can be set to the remainder excluding the other components from the hydrolyzed liquid, but the content of the surface-modifying material in the hydrolyzed liquid is, for example, 60% by mass or more and 99% by mass or less, preferably 70% by mass or more and 97% by mass or less, and more preferably 80% by mass or more and 95% by mass or less.

In addition, in the present step, the hydrolyzed liquid contains water. Water serves as a substrate for the hydrolysis reaction of the surface-modifying material.

The content of water in the hydrolyzed liquid is not particularly limited and can be arbitrarily selected. For example, the content of water can be appropriately set in accordance with the amount of the surface-modifying material. For example, the amount of water that is added to the hydrolyzed liquid is preferably 0.5 mol or more and 5 mol or less, more preferably 0.6 mol or more and 3 mol or less, and still more preferably 0.7 mol or more and 2 mol or less with respect to 1 mol of the surface-modifying material. In such a case, it is possible to more reliably prevent the occurrence of the agglomeration of the inorganic particles in a dispersion liquid to be produced due to the excess amount of water while causing the hydrolysis reaction of the surface-modifying material to sufficiently progress. The content of water in the hydrolyzed liquid may be, for example, 1% by mass or more and 40% by mass or less, may be 3% by mass or more and 30% by mass or less, and may be 5% by mass or more and 20% by mass or less or 8% by mass or more and 13% by mass or less.

Alternatively, the content of water in the hydrolyzed liquid may be, for example, 1% by mass or more and 20% by mass or less, preferably 1% by mass or more and 15% by mass or less, and more preferably 1% by mass or more and 10% by mass or less.

In addition, a catalyst may be added to the hydrolyzed liquid. The hydrolyzed liquid may contain only the surface-modifying material, water, and the catalyst. As the catalyst, for example, an acid or a base can be used.

The acid catalyzes the hydrolysis reaction of the surface-modifying material in the hydrolyzed liquid and in the liquid mixture that is prepared to contain the hydrolyzed liquid. On the other hand, the base catalyzes a condensation reaction between the hydrolyzed surface-modifying material and functional groups on the surfaces of the inorganic particles, for example, hydroxyl groups or silanol groups. These reactions make it easy for the surface-modifying material to be attached to the inorganic particles and improve the dispersion stability of the inorganic particles.

Here, the above-described “acid” refers to an acid based on the so-called Bronsted-Lowry definition and, here, refers to a substance that donates a proton in the hydrolysis reaction of the surface-modifying material. In addition, the above-described “base” refers to a base based on the so-called Bronsted-Lowry definition and refers herein to a substance that accepts a proton in the hydrolysis reaction of the surface-modifying material and the following condensation reaction.

The acid that can be used in the production method according to the present embodiment is not particularly limited as long as it can supply protons in the hydrolysis reaction of the surface-modifying material, and can be arbitrarily selected. Examples of the acid include inorganic acids such as hydrochloric acid, hydrobromic acid, hydroiodic acid, sulfuric acid, nitric acid, boric acid, and phosphoric acid and organic acids such as acetic acid, citric acid and formic acid. One of these acids can be used singly or two or more thereof can be used in combination.

The base that can be used in the production method according to the present embodiment is not particularly limited as long as it can accept protons in the hydrolysis reaction of the surface-modifying material or the subsequent condensation reaction, and can be arbitrarily selected. Examples thereof include sodium hydroxide, potassium hydroxide, barium hydroxide, calcium hydroxide, ammonia, amines, and the like. One of these bases can be used singly or two or more thereof can be used in combination.

Among the above-described catalysts, the acid is preferably used as the catalyst. As the acid, the inorganic acid is preferable, and hydrochloric acid is more preferable from the viewpoint of the acidity.

The content of the catalyst in the hydrolyzed liquid is not particularly limited and can be arbitrarily selected. The content of the catalyst in the hydrolyzed liquid may be, for example, 10 ppm or more and 1000 ppm or less, preferably 20 ppm or more and 800 ppm or less, and more preferably 30 ppm or more and 600 ppm or less. In such a case, it is possible to suppress an unintended side reaction of the surface-modifying material while sufficiently accelerating the hydrolysis of the surface-modifying material. The content of the catalyst in the hydrolyzed liquid may be 0.1 ppm or more and 100 ppm or less or 1 ppm or more and 10 ppm or less as necessary. In addition, for example, when hydrochloric acid (1N) is used as the catalyst, the amount of hydrochloric acid may be 0.001 parts by mass or more and 5 parts by mass or less, may be 0.001 parts by mass or more and 3 parts by mass or less, may be 0.005 parts by mass or more and 1 part by mass or less, or may be 0.005 parts by mass or more and 0.1 parts by mass or less with respect to 100 parts by mass in the hydrolyzed liquid.

In addition, the hydrolyzed liquid may contain a hydrophilic solvent as necessary. The hydrophilic solvent is capable of further accelerating the hydrolysis reaction of the surface-modifying material by accelerating the mixing of water and the surface-modifying material in the hydrolyzed liquid.

Examples of such a hydrophilic solvent include alcohol-based solvents, ketone-based solvents, nitrile-based solvents, and the like. It is possible to preferably use one of these singly or two or more thereof in combination.

Examples of the alcohol-based solvents include branched or linear alcohol compounds having 1 to 4 carbon atoms and ether condensates thereof. These solvents can be used singly or two or more thereof can be used in combination. In addition, an alcohol compound that is contained in the alcohol-based solvents may be any of primary, secondary and tertiary alcohols. In addition, the alcohol compound that is contained in the alcohol-based solvents may be any of monohydric, divalent, and trihydric alcohols. More specifically, preferable examples of the alcohol-based solvents include methanol, ethanol, 1-propanol, isopropyl alcohol, 1-butyl alcohol, 2-butanol, isobutyl alcohol, tert-butyl alcohol, methanediol, 1,2-ethanediol, 1,2-propanediol, 1,3-propanediol, 1,2-butanediol, 1,3-butanediol, 1,4-butanediol, 2,3-butanediol, 2-butene-1,4-diol, 1,4-butynediol, glycerin, diethylene glycol, 3-methoxy-1,2-propanediol, and the like.

Preferable examples of the ketone-based solvents include acetone, methyl ethyl ketone, methyl isobutyl ketone, cyclohexanone, and the like.

Preferable examples of the nitrile-based solvents include acetonitrile and the like.

Among the above-described hydrophilic solvents, the hydrophilic solvent preferably contains the alcohol-based solvent from the viewpoint of excellent affinity to both water and the hydrophobic solvent and acceleration of the mixing thereof. In this case, the number of carbon atoms in the alcohol compound that configures the alcohol-based solvent is preferably 1 or more and 3 or less and more preferably 1 or more and 2 or less. The hydrophilic solvent may be made of an alcohol-based solvent alone.

Among the above-described alcohol-based solvents, methanol and ethanol are preferable. Particularly, methanol can be preferably used since it is possible to sufficiently develop the effect of the above-described alcohol-based solvents.

In addition, the content of the hydrophilic solvent in the hydrolyzed liquid is not particularly limited and can be, for example, 60% by mass or less and preferably 50% by mass or less. In this range, it is possible to sufficiently increase the content of the surface-modifying material and water in the hydrolyzed liquid. The content of the hydrophilic solvent may be 40% by mass or less, 20% by mass or less, 10% by mass or less, or 5% by mass or less. In addition, the content of the hydrophilic solvent in the hydrolyzed liquid can be, for example, 10% by mass or more and preferably 15% by mass or more. In this range, it is possible to further accelerate the mixing of the surface-modifying material and water and, consequently, to cause the hydrolysis reaction of the surface-modifying material to efficiently progress. The hydrolyzed liquid may not contain any hydrophilic solvents except for a compound derived from the hydrolysis reaction. That is, only a hydrophilic solvent that is a compound derived from the hydrolysis reaction may be contained.

In the present embodiment, in the case of using a compound having an alkoxy group, for example, a silane compound having an alkoxy group as the surface-modifying material, since this compound is hydrolyzed, an alcohol compound derived from the alkoxy group is contained in the liquid mixture. Since the hydrolysis reaction progresses even in inorganic particle-adsorbed water and thus can occur in any of the hydrolysis step, the mixing step, and the dispersion step. Therefore, in this case, an alcohol compound is contained in the final dispersion liquid unless a step of removing the alcohol compound is provided.

In the present step, after prepared, the hydrolyzed liquid may be held at a certain temperature that is arbitrarily selected for a predetermined time. This makes it possible for the hydrolysis of the surface-modifying material to be further accelerated.

In this treatment, the temperature of the hydrolyzed liquid is not particularly limited, can be arbitrarily selected, and can be appropriately changed depending on the kind of the surface-modifying material. For example, the temperature of the hydrolyzed liquid is 5° C. or higher and 65° C. or lower, more preferably 20° C. or higher and 65° C. or lower, and further preferably 30° C. or higher and 60° C. or lower. The temperature of the hydrolyzed liquid may be 40° C. or higher and 75° C. or lower or 50° C. or higher and 70° C. or lower as necessary.

In addition, the holding time at the above-described temperature is not particularly limited and is, for example, 10 minutes or longer and 180 minutes or shorter and preferably 30 minutes or longer and 120 minutes or shorter. The holding time may be 15 minutes or longer and 60 minutes or shorter or 20 minutes or longer and 40 minutes or shorter as necessary.

While the hydrolyzed liquid is being held, the hydrolyzed liquid may be appropriately stirred.

In addition, the present step can be carried out as necessary and may be omitted.

(2.2 Mixing Step)

In the present step, at least the surface-modifying material and the inorganic particles are mixed to obtain a liquid mixture. In the case of obtaining the hydrolyzed liquid containing the surface-modifying material by the above-described hydrolysis step, the liquid mixture is obtained by mixing the hydrolyzed liquid and the inorganic particles. In this hydrolyzed liquid, in addition to the surface-modifying material, the above-described compound or a solvent can be contained. The liquid mixture is preferably made up of only the hydrolyzed liquid and the inorganic particles.

In this step, the surface-modifying material and the inorganic particles are mixed such that the content of the inorganic particles in the liquid mixture is 10% by mass or more and 49% by mass or less and the total content of the surface-modifying material and the inorganic particles is 65% by mass or more and 98% by mass or less. The amounts and proportions of the individual materials may be adjusted in advance such that the above-described contents are satisfied in the mixing step.

As described above, in the present embodiment, the total content of the surface-modifying material and the inorganic particles in the liquid mixture is 65% by mass or more and 98% by mass or less, which is extremely large. In addition, an organic solvent or a dispersion medium such as water that has been regarded as essential in the related art is not contained in the liquid mixture or is contained in an extremely small amount compared with the related art. Alternatively, a small amount of an unavoidable alcohol compound is contained due to the hydrolysis. The present inventors found that, even in such a case, the inorganic particles undergo the dispersion step in the liquid mixture, whereby the inorganic particles can be uniformly dispersed, and the surface-modifying material can be uniformly attached to the inorganic particles (surface modification).

Here, the surface-modifying material “being attached to” the inorganic particles refers to the fact that the surface-modifying material comes in contact with or bonds to the inorganic particles by an interaction therebetween. As the contact, for example, physical adsorption is exemplified. In addition, as the bond, an ionic bond, a hydrogen bond, a covalent bond, and the like are exemplified.

In contrast, in a case where the total content of the surface-modifying material and the inorganic particles is less than 65% by mass, since the amount of components other than the above-described two components, for example, the dispersion medium becomes too large, there is a strong tendency that it is not possible to sufficiently attach the surface-modifying material to the surfaces of the inorganic particles in the dispersion step to be described below. As a result, a large number of hydroxyl groups remain on the surfaces of the inorganic particles, and, when a dispersion that is obtained by dispersion is mixed with a highly hydrophobic material afterwards, the inorganic particles agglomerate, and the highly hydrophobic material becomes turbid. The total content of the surface-modifying material and the inorganic particles needs to 65% by mass or more and is preferably 70% by mass or more and more preferably 75% by mass or more. The total content of the surface-modifying material and the inorganic particles may be 80% by mass or more, 85% by mass or more, 90% by mass or more, or 92% by mass or more as necessary.

In contrast, in a case where the total content of the surface-modifying material and the inorganic particles exceeds 98% by mass, the viscosity of the liquid mixture becomes too high, and there is a strong tendency that it is not possible to sufficiently attach the surface-modifying material to the surfaces of the inorganic particles in the dispersion step to be described below. The total content of the surface-modifying material and the inorganic particles needs to 98% by mass or less and is preferably 97% by mass or less and more preferably 95% by mass or less. The total content of the surface-modifying material and the inorganic particles may be 90% by mass or less, 85% by mass or less, 80% by mass or less, or 75% by mass or less as necessary.

In addition, as described above, the content of the inorganic particles in the liquid mixture is 10% by mass or more and 49% by mass or less. With such a range, it is possible to control the amount of the surface-modifying material with respect to the inorganic particles to be within an appropriate range, to uniformly attach the surface-modifying material to the surfaces of the inorganic particles, and to suppress an increase in the viscosity of the liquid mixture. The content of the surface-modifying material in the liquid mixture may be 16% by mass or more and 88% by mass or less.

On the other hand, in a case where the content of the inorganic particles in the liquid mixture is less than 10% by mass, the amount of the surface-modifying material becomes excessive with respect to the inorganic particles, and there is a strong tendency for the excess surface-modifying material to induce the agglomeration of the inorganic particles in a dispersion liquid to be obtained.

The content of the inorganic particles in the liquid mixture is preferably 20% by mass or more, still more preferably 23% by mass or more, still more preferably 26% by mass or more, and particularly preferably 30% by mass or more.

In addition, when the content of the inorganic particles exceeds 49% by mass, the amount of the surface-modifying material with respect to the inorganic particles is deficient, and a sufficient amount of the surface-modifying material is not attached to the inorganic particles. In addition, the content of the inorganic particles becomes too large, consequently, the viscosity of the liquid mixture becomes too high, and there is a strong tendency that it is not possible to sufficiently disperse the inorganic particles in the dispersion step to be described below. The content of the inorganic particles in the liquid mixture is preferably 45% by mass or less, more preferably 40% by mass or less, still more preferably 38% by mass or less, and particularly preferably 36% by mass or less. The content of the inorganic particles in the liquid mixture may be 34% by mass or less.

The ratio of the content of the surface-modifying material to the content of the inorganic particles in the liquid mixture is not particularly limited, but is, for example, 100% by mass or more and 800% by mass or less, preferably 140% by mass or more and 600% by mass or less, more preferably 180% by mass or more and 400% by mass or less, and particularly preferably 200% by mass or more and 270% by mass or less with respect to 100% by mass of the amount of the inorganic particles. In such a case, it is possible to control the amount of the surface-modifying material with respect to the inorganic particles to be within an appropriate range and to uniformly attach the surface-modifying material to the surfaces of the inorganic particles.

The inorganic particles that are contained in the liquid mixture according to the present embodiment are not particularly limited. In the present embodiment, as the inorganic particles, for example, inorganic oxide particles containing at least one or more kinds selected from the group consisting of zirconium oxide particles, titanium oxide particles, silica particles, zinc oxide particles, iron oxide particles, copper oxide particles, tin oxide particles, cerium oxide particles, tantalum oxide particles, niobium oxide particles, tungsten oxide particles, europium oxide particles, yttrium oxide particles, molybdenum oxide particles, indium oxide particles, antimony oxide particles, germanium oxide particles, lead oxide particles, bismuth oxide particles, and hafnium oxide particles and potassium titanate particles, barium titanate particles, strontium titanate particles, potassium niobate particles, lithium niobate particles, calcium tungstate particles, yttria-stabilized zirconia particles, alumina-stabilized zirconia particles, silica-stabilized zirconia particles, calcia-stabilized zirconia particles, magnesia-stabilized zirconia particles, scandia-stabilized zirconia particles, hafnia-stabilized zirconia particles, ytterbia-stabilized zirconia particles, ceria-stabilized zirconia particles, india-stabilized zirconia particles, strontium-stabilized zirconia particles, samarium oxide-stabilized zirconia particles, gadolinium oxide-stabilized zirconia particles, antimony-added tin oxide particles, and indium-added tin oxide particles are preferably used.

The mixing time or mixing temperature in the mixing step can be arbitrarily selected. For example, the mixing may be carried out at room temperature or the materials may be well mixed and then stirred for approximately 0 to 600 seconds.

The kind of the inorganic particles can be appropriately selected depending on the use of a dispersion liquid to be obtained. For example, in the case of using the inorganic particles in the dispersion liquid to be obtained as a material for sealing members for light-emitting elements, the liquid mixture preferably contains at least one kind selected from the group consisting of zirconium oxide particles, titanium oxide particles, and silica particles from the viewpoint of improving transparency or compatibility (affinity) with a sealing resin (resin component). In addition, the inorganic particles preferably have a refractive index of 1.7 or higher from the viewpoint of improving the refractive index of the sealing member. Examples of such inorganic particles include inorganic oxide particles other than the above-described silica particles. In the case of being used as a material for sealing members, the inorganic particles are more preferably zirconium oxide particles and/or titanium oxide particles and particularly preferably zirconium oxide particles.

The inorganic particles may be dispersed as primary particles in the liquid mixture or may be dispersed as secondary particles that are agglomerates of the primary particles. Usually, the inorganic particles are dispersed in the liquid mixture as secondary particles.

The average primary particle diameter of the inorganic particles to be used can be arbitrarily selected and is, for example, 3 nm or more and 200 nm or less, preferably 5 nm or more and 170 nm or less, and more preferably 10 nm or more and 100 nm or less. The average primary particle diameter of the inorganic particles may be 5 to 20 nm, may be 5 to 25 nm, or may be 50 to 120 nm or 50 to 150 nm as necessary. When the average primary particle diameter is in the above-described range, the transparency of the dispersion liquid is enhanced. In addition, in the case of using the inorganic particles as a material for sealing members for light-emitting elements, for example, light-emitting diodes (LEDs), it is possible to improve the brightness of the light-emitting elements (LEDs).

The average primary particle diameter of the inorganic particles can be measured by, for example, observation with a transmission electron microscope. First, a collodion film obtained by collecting the inorganic particles from the dispersion liquid is observed with a transmission electron microscope, and a transmission electron microscopic image is obtained. Next, a predetermined number (for example, 100) of the inorganic particles in the transmission electron microscopic image are selected. In addition, the longest straight-line segments (longest diameters) of the individual inorganic particles are measured, and these measurement values are arithmetically averaged, thereby obtaining the average primary particle diameter.

Here, in a case where the inorganic particles agglomerate together, the measurement subject is not the agglomerated particle diameter of this agglomerate. The longest diameters of a predetermined number of particles (primary particles) of the inorganic particles that configure this agglomerate are measured, and the average primary particle diameter is obtained.

In addition, in the present step, an organic solvent may be further mixed with the liquid mixture. When the organic solvent is mixed with the liquid mixture, it becomes possible to control the reactivity of the surface-modifying material, and it becomes possible to control the degree of attachment of the surface-modifying material to the surfaces of the inorganic particles. Furthermore, it becomes possible to adjust the viscosity of the liquid mixture with the organic solvent.

Examples of such an organic solvent include an alcohol-based solvent, a ketone-based solvent, an aromatic solvent, a saturated hydrocarbon-based solvent, an unsaturated hydrocarbon-based solvent, and the like, and one of these may be used singly or two or more thereof may be used in combination.

In a case where the surface-modifying material has been hydrolyzed in the mixing step, a compound derived from the surface-modifying material, for example, an alcohol-based solvent is contained in the liquid mixture.

The content of the organic solvent in the liquid mixture is not particularly limited as long as it satisfies the contents of the inorganic particles and the surface-modifying material are satisfied. It is needless to say that the organic solvent may not be contained in the liquid mixture.

In addition, components other than the components described above, for example, general additives such as a dispersant, a dispersion aid, an antioxidant, a flow adjuster, a viscosity improver, a pH adjuster, and a preservative may be mixed with the liquid mixture as necessary.

(2.3 Dispersion Step)

Next, the inorganic particles are dispersed in the liquid mixture to obtain a dispersion liquid in which the inorganic particles are dispersed. The inorganic particles can be dispersed by a well-known dispersion method, for example, the use of a well-known disperser. As the disperser, for example, a bead mill, a ball mill, a homogenizer, a disperser, a stirrer, or the like is preferably used. The dispersion step is preferably a step of dispersing only the mixture obtained in the mixing step.

Here, in the present step, the inorganic particles are preferably dispersed by imparting the minimum necessary amount of energy without imparting excess energy such that the particle diameters (dispersed-particle diameters) of the inorganic particles become almost uniform in the dispersion liquid.

The dispersion time can be arbitrarily selected depending on conditions, may be, for example, 6 to 18 hours, and is preferably 8 to 12 hours and more preferably 10 to 11 hours. However, the dispersion temperature is not limited only thereto.

The dispersion temperature can be arbitrarily selected, may be, for example, 10° C. to 50° C., and is preferably 20° C. to 40° C. and more preferably 30° C. to 40° C. However, the dispersion temperature is not limited only thereto.

A difference of the dispersion step from the mixing step is that the inorganic particles are continuously dispersed over a certain period of time.

A dispersion liquid can be obtained as described above. In the dispersion liquid produced using the method according to the present embodiment, the inorganic particles are uniformly dispersed, and the surfaces of the inorganic particles are uniformly and sufficiently modified with the surface-modifying material. Furthermore, in a case where the highly hydrophobic material and the dispersion liquid have been mixed afterwards, the inorganic particles can be uniformly dispersed in the highly hydrophobic material. As a result, turbidity, for example, white turbidity of the highly hydrophobic material is prevented. Therefore, the color tone of the highly hydrophobic material is rarely affected, and the intended function of the inorganic particles is exhibited.

<3. Dispersion Liquid>

Next, a dispersion liquid according to the present embodiment will be described. The dispersion liquid according to the present embodiment contains inorganic particles and one or more surface-modifying materials that are at least partially attached to the inorganic particles. The content of the inorganic particles is 10% by mass or more and 49% by mass or less, and the total content of the surface-modifying material and the inorganic particles is 65% by mass or more and 98% by mass or less.

The total content of the surface-modifying material and the inorganic particles can also be evaluated by the solid content. The solid content can be measured by a method to be described below.

In the present embodiment, the dispersion liquid is produced by the above-described method for producing a dispersion liquid according to the present embodiment. Therefore, the inorganic particles are uniformly dispersed, and the surfaces of the inorganic particles are uniformly and sufficiently modified with the surface-modifying material. Furthermore, in a case where the highly hydrophobic material and the obtained dispersion liquid have been mixed, the inorganic particles can be uniformly dispersed in the highly hydrophobic material, and white turbidity of the hydrophobic material is prevented. As a result, the color tone of the highly hydrophobic material is rarely affected, and the intended function of the inorganic particles is exhibited.

In addition, the dispersion liquid according to the present embodiment is capable of more significantly obtaining the above-described effect in the case of inorganic particles that are not easily dispersible, for example, fine inorganic particles.

The volume-based 50% particle diameter D50 of the inorganic particles in the obtained dispersion liquid is not particularly limited, but is, for example, 30 nm or more and 400 nm or less, preferably 40 nm or more and 300 nm or less, and more preferably 50 nm or more and 250 nm or less. The volume-based 50% particle diameter D50 may be 30 nm or more and 80 nm or less, 30 nm or more and 100 nm or less, 80 nm or more and 180 nm or less, or the like as necessary. Generally, when the particle diameters are is in the above-described range, the inorganic particles are likely to agglomerate due to a high specific surface area. However, in the dispersion liquid according to the present embodiment, the surface-modifying material is uniformly and sufficiently attached to the inorganic particles. Therefore, stable dispersion of the inorganic particles is possible. In addition, even when the dispersion liquid has been mixed with the highly hydrophobic material, the agglomeration of the inorganic particles is suppressed, and the inorganic particles can be stably dispersed in the highly hydrophobic material.

Furthermore, when the volume-based 90% particle diameter of the inorganic particles is represented by D90, and the volume-based 50% particle diameter of the inorganic particles is represented by D50, D90/D50 is not particularly limited and is, for example, 1.0 or more and 3.0 or less, preferably 1.0 or more and 2.5 or less, and more preferably 1.0 or more and 2.3 or less. D90/D50 may be 1.4 or more and 2.3 or less, 1.6 or more and 2.1 or less, or 1.8 or more and 2.0 or less as necessary. D90/D50 is an indicator of the shape of the particle size distribution of the inorganic particles and serves as one of indexes of the uniformity of the particle diameters of the inorganic particles. When D90/D50 is in the above-described range, the particle diameters of the inorganic particles in the dispersion liquid becomes relatively uniform. In addition, the inorganic particles having such uniform particle diameters in the dispersion liquid according to the present embodiment are relatively stable and can be uniformly dispersed even in the highly hydrophobic material. Such a D90/D50 range can be relatively easily achieved by the above-described method for producing a dispersion liquid according to the present embodiment.

D50 and D90 of the inorganic particles can be the particle diameters D50 and D90 of the inorganic particles when the cumulative percentages of a scattering intensity distribution that is obtained by a dynamic light scattering method are 50% and 90%, respectively. D10, D50, and D90 can be measured with a dynamic light scattering-type particle size distribution meter (for example, manufactured by Horiba, Ltd., Model No.: SZ-100SP). The measurement can be carried out on the dispersion liquid having a solid content adjusted with an alcohol compound to 5% by mass as a subject using a silica cell having a 10 mm×10 mm optical path length.

In the present specification, “solid content” refers to a residue when a volatile component has been removed from the dispersion liquid. For example, when the dispersion liquid (1.2 g) is put into a magnetic crucible and heated at 100° C. for one hour on a hot plate, a component that does not volatilize but remains (the inorganic particles, the surface-modifying material, or the like) can be regarded as the solid content.

In addition, D50 and D90 of the inorganic particles are measured and calculated based on the diameters of the inorganic particles in a dispersed state regardless of whether the inorganic particles are dispersed in a primary particle or secondary particle state. In addition, in the present embodiment, D50 and D90 of the inorganic particles may be measured as D50 and D90 of the inorganic particles to which the surface-modifying material is attached. In the dispersion liquid, the inorganic particles to which the surface-modifying material has been attached and the inorganic particles to which the surface-modifying material is not attached can be present. Therefore, usually, D50 and D90 of the inorganic particles can be measured as a value in a mixed state thereof.

The average primary particle diameter of the inorganic particles is, for example, 3 nm or more and 200 nm or less, preferably 5 nm or more and 170 nm or less, and more preferably 10 nm or more and 100 nm or less. When the average primary particle diameter is in the above-described range, the transparency of the dispersion liquid is enhanced. In addition, in the case of using the inorganic particles as a material for sealing members for light-emitting elements, for example, light-emitting diodes (LEDs), it is possible to improve the brightness of the LEDs.

The kinds and contents of the inorganic particles and the surface-modifying material or other components in the dispersion liquid are the same as those in the above-described liquid mixture and thus will not be described again.

However, in a case where a decomposition reaction such as hydrolysis occurs at the time of attaching the surface-modifying material to the inorganic particles, the content of the surface-modifying material in the dispersion liquid can be small compared with the content of the surface-modifying material in the liquid mixture. Therefore, the total content of the surface-modifying material and the inorganic particles in the dispersion liquid can also be small compared with the total content of the surface-modifying material and the inorganic particles in the liquid mixture. In addition, the amount of a compound that is generated by the decomposition reaction, for example, an alcohol-based compound, can be increased in the dispersion liquid compared with the case of the liquid mixture.

As described above, in a case where the dispersion liquid according to the present embodiment has been mixed with the highly hydrophobic material, the inorganic particles can be uniformly dispersed in the highly hydrophobic material, and the white turbidity of the highly hydrophobic material can be suppressed. The highly hydrophobic material may mean a poorly hydrophilic material. Examples of the highly hydrophobic material can be arbitrarily selected, and examples thereof include organic solvents, resin materials, fats and oils, and the like containing a large amount of carbon or a hydrophobic group. Preferable examples of the organic solvents include aromatic solvents, saturated hydrocarbons, and unsaturated hydrocarbons. One organic solvent may be used or two or more organic solvents may be used. More specific examples of the highly hydrophobic material include silicone resins, for example, silicone containing a large number of methyl groups such as a dimethyl silicone resin. More specific examples of the material include methyl phenyl silicone, toluene, methoxy group-containing phenyl silicone resins, benzene, ethylbenzene, 1-phenylpropane, isopropylbenzene, n-butylbenzene, tert-butylbenzene, sec-butylbenzene, o-, m- or p-xylene, 2-, 3- or 4-ethyltoluene, and the like. However, the highly hydrophobic material is not limited only to these.

In addition, in the case of using the dispersion liquid according to the present embodiment, it is possible to uniformly disperse fine inorganic particles in highly hydrophobic materials. Therefore, the dispersion liquid according to the present embodiment is suitable as a material for members requiring uniform dispersion of fine inorganic particles in highly hydrophobic materials, for example, optical members such as sealing members for light-emitting elements. Therefore, the dispersion liquid according to the present embodiment can be preferably used as a dispersion liquid for an optical member, particularly, a dispersion liquid for a sealing member for light-emitting elements.

### EXAMPLES

Hereinafter, the present invention will be described in more detail using examples. The examples to be described below are simply examples of the present invention and do not limit the present invention.

### Example 1

(1. Production of Dispersion Liquid)

(i) Hydrolysis Step

90.78 Parts by mass of methyltrimethoxysilane (manufactured by Shin-Etsu Chemical Co., Ltd., product name: KBM-13) as a surface-modifying material, 9.21 parts by mass of water, and 0.01 parts by mass of hydrochloric acid (1N) were prepared. These were added to a container and mixed together to obtain a hydrolyzed liquid. Next, this hydrolyzed liquid was stirred at 60° C. for 30 minutes, and a hydrolysis treatment of methyltrimethoxysilane was carried out. The numbers of moles of methyltriethoxysilane and water that were added to the hydrolyzed liquid are almost the same.

(ii) Mixing Step

30 Parts by mass of zirconium oxide particles having an average primary particle diameter of 12 nm (manufactured by Sumitomo Osaka Cement Co., Ltd.) and 70 parts by mass of the hydrolyzed liquid were mixed to obtain a liquid mixture. The content of the zirconium oxide particles in the liquid mixture was 30% by mass, the content of methyltrimethoxysilane was 63.5% by mass, and the total content of the zirconium oxide particles and methyltrimethoxysilane was 93.5% by mass.

(iii) Dispersion Step

This liquid mixture was dispersed with a bead mill for 10 hours at room temperature. After this, beads were removed, and a dispersion liquid according to Example 1 was obtained.

As a result of measuring the solid content of the dispersion liquid (residual component after being heated at 100° C. for 1 hour), the amount of the solid content was 70% by mass.

(2. Evaluation)

(2.1 Evaluation of Particle Size Distribution of Dispersion Liquid)

A part of the obtained dispersion liquid was collected, and D10, D50, and D90 of the dispersion liquid adjusted with methanol such that the solid content became 5% by mass were measured using a particle size distribution meter (manufactured by HORIBA, Ltd., Model No.: SZ-100SP). As a result, D10 was 15 nm, D50 was 65 nm, and D90 was 108 nm. Particles that were contained in the dispersion liquid had been treated with a large amount of the surface-modifying material and were thus basically considered as only zirconium oxide particles to which the surface-modifying material was attached. From this fact, the measured D10, D50, and D90 were considered to be D10, D50, and D90 of the zirconium oxide particles to which the surface-modifying material was attached. In addition, D90/D50 was 1.66.

(2.2 Evaluation of Mixing Stability with Hydrophobic Resin)

The mixing stability with a hydrophobic resin was evaluated by the following method.

(i) Silicone Treatment

First, a dispersion liquid for evaluation was prepared. In each of the following evaluations (ii) to (v), this dispersion liquid for evaluation was turned into a final dispersion liquid or a final composition by further carrying out an additional treatment as necessary and was used for each evaluation.

39.0 Parts by mass of the dispersion liquid according to Example 1, 8.6 parts by mass of a methoxy group-containing phenyl silicone resin (KR217 manufactured by Shin-Etsu Chemical Co., Ltd.), and 52.4 parts by mass of toluene were added and mixed at 110° C. for 18 hours, thereby obtaining a dispersion liquid for evaluation in which the surfaces of the zirconium oxide particles were treated with silicone.

In the above-described formulation, since the measurement result of the solid content of the obtained dispersion liquid for evaluation was 70% by mass, toluene was added such that the solid content in the dispersion liquid for evaluation became 30% by mass.

(ii) Evaluation of Dispersion Liquid (Confirmation of Uniformity of Particle Diameters of Inorganic Particles)

A part of the obtained dispersion liquid for evaluation was collected, and toluene was further added thereto, thereby preparing a dispersion liquid (final dispersion liquid) having a solid content adjusted to 5% by mass. D10, D50, and D90 of this dispersion liquid were measured using a particle size distribution meter (manufactured by Horiba, Ltd., model No.: SZ-100SP). As a result, D10 was 54 nm, D50 was 108 nm, and D90 was 213 nm. It is conceivable that the particles that were contained in the dispersion liquid for evaluation were basically only zirconium oxide particles to which the surface-modifying material was attached. Therefore, the measured D10, D50, and D90 were considered to be D10, D50, and D90 of the zirconium oxide particles in this dispersion liquid.

(iii) Evaluation of Mixing with Hydrophobic Resin (Confirmation of Suppression of Agglomeration)

5 g Of the dispersion liquid for evaluation and 3.5 g of methyl phenyl silicone (manufactured by Shin-Etsu Chemical Co., Ltd., KER-2500-B) were mixed.

Next, toluene was removed from this liquid mixture with an evaporator to obtain a composition (final composition) for sealing an LED to be described below.

As a result of visually observing the appearance of the obtained composition, the composition was transparent.

(iv) Evaluation of Stability of Composition (Confirmation of Stability)

The viscosity of the composition (final composition) was measured using a rheometer (RHEOSTRESS RS-6000, manufactured by HAAKE) under conditions of 25° C. and a shear rate of 1 (1/s).

As a result, the viscosity immediately after the production was 10 Pa·s.

This composition was stored at room temperature (25° C.), and the viscosity was measured after 1 month. As a result, the viscosity of the composition was 50 Pa s, which showed that the viscosity increased but was low enough to withstand practical use.

(v) Production of LED Package (Confirmation of Use in Light-Emitting Element)

14 Parts by mass of a methyl phenyl silicone resin (“KER-2500-A/B” manufactured by Shin-Etsu Chemical Co., Ltd. was added to 1 part by mass of the obtained composition (final composition) and adjusted and mixed such that the surface-modified zirconium oxide particles became 2% by mass in the composition. 0.38 Parts by mass of the particles of a fluorescent body (yttrium aluminum garnet: YAG) were mixed with 1 part by mass of the obtained composition. The obtained composition (total amount of surface-modified zirconium oxide particles and resin:particles of fluorescent body=100:38) was loaded into an LED lead frame in a thickness of 300 μm. After that, the composition was held at room temperature for 3 hours. Next, the composition was slowly heated and cured to form a sealing member, thereby producing a white LED package.

The brightness of the obtained white LED package was measured by applying a voltage of 3 V and an electric current of 150 mA to the LED package with a total luminous flux measurement system (manufactured by Otsuka Electronics Co., Ltd.) and measuring the intensity of light. As a result, the brightness of this white LED package was 73.2 lm.

### Example 2

Evaluation was carried out in the same manner as in Example 1 except that zirconium oxide particles having different particle diameters were used.

(1. Production of Dispersion Liquid)

Instead of the zirconium oxide particles having an average primary particle diameter of 12 nm, zirconium oxide particles having an average primary particle diameter of 90 nm (manufactured by Sumitomo Osaka Cement Co., Ltd.) were used. A dispersion liquid according to Example 2 was obtained by carrying out a hydrolysis step, a mixing step, and a dispersion step in the same manner as in Example 1 except for the zirconium oxide particles. The content of the zirconium oxide particles in the liquid mixture obtained in the mixing step was 30% by mass, the content of methyltrimethoxysilane was 63.5% by mass, and the total content of the zirconium oxide particles and methyltrimethoxysilane was 93.5% by mass.

As a result of measuring the solid content of the dispersion liquid (at 100° C. for 1 hour), the amount of the solid content was 70% by mass.

(2. Evaluation)

(2.1 Evaluation of Particle Size Distribution of Dispersion Liquid)

D10, D50, and D90 of the inorganic particles in the dispersion liquid were measured in the same manner as in Example 1. As a result, D10 was 54 nm, D50 was 120 nm, and D90 was 223 nm. D90/D50 was 1.86.

(2.2 Evaluation of Mixing Stability with Hydrophobic Resin)

(i) Silicone Treatment

A dispersion liquid for evaluation containing 30% by mass of a solid content was obtained by carrying out a silicone treatment in the same manner as in Example 1 except for the fact that the dispersion liquid according to Example 2 was used instead of the dispersion liquid according to Example 1.

(ii) Evaluation of Dispersion Liquid

As a result of evaluating this dispersion liquid for evaluation in the same manner as in Example 1, D10 was 95 nm, D50 was 184 nm, and D90 was 284 nm.

(iii) Evaluation of Mixing with Hydrophobic Resin

The obtained dispersion liquid for evaluation was mixed with methyl phenyl silicone in the same manner as in Example 1, and toluene was removed, thereby obtaining a composition. As a result of visually observing the appearance of the obtained composition, the composition was transparent.

(iv) Evaluation of Stability of Composition

The viscosity of the composition was measured using a rheometer (RHEOSTRESS RS-6000, manufactured by HAAKE) under conditions of 25° C. and a shear rate of 1 (1/s).

As a result, the viscosity immediately after the production was 10 Pa s.

This composition was stored at room temperature (25° C.), and the viscosity was measured after 1 month. As a result, the viscosity of the composition was 40 Pa s, which showed that the viscosity increased but was low enough to withstand practical use.

### Comparative Example 1

Evaluation was carried out in the same manner as in Example 1 except that isopropyl alcohol was added to the hydrolyzed liquid at a high rate.

(1. Production of Dispersion Liquid)

In the mixing step, 20 parts by mass of the hydrolyzed liquid and 50 parts by mass of isopropyl alcohol were used instead of 70 parts by mass of the hydrolyzed liquid. A dispersion liquid (solid content: 30% by mass) according to Comparative Example 1 was obtained by carrying out a hydrolysis step, a mixing step, and a dispersion step in the same manner as in Example 1 except for the zirconium oxide particles. The content of the zirconium oxide particles in the liquid mixture obtained in the mixing step was 30% by mass, the content of methyltrimethoxysilane was 18.2% by mass, and the total content of the zirconium oxide particles and methyltrimethoxysilane was 48.2% by mass.

As a result of measuring the solid content of the first dispersion liquid (at 100° C. for 1 hour), the amount of the solid content was 38% by mass.

(2. Evaluation)

(2.1 Evaluation of Particle Size Distribution of Dispersion Liquid)

D10, D50, and D90 of the inorganic particles in the dispersion liquid were measured in the same manner as in Example 1. As a result, D10 was 13 nm, D50 was 62 nm, and D90 was 95 nm. D90/D50 was 1.53.

(2.2 Evaluation of Mixing Stability with Hydrophobic Resin)

(i) Silicone Treatment

A dispersion liquid for evaluation containing 30% by mass of a solid content was obtained by carrying out a silicone treatment in the same manner as in Example 1 except for the fact that the dispersion liquid according to Comparative Example 1 was used instead of the dispersion liquid according to Example 1.

(ii) Evaluation of Dispersion Liquid

As a result of evaluating this dispersion liquid for evaluation in the same manner as in Example 1, D10 was 52 nm, D50 was 105 nm, and D90 was 195 nm.

(iii) Evaluation of Mixing with Hydrophobic Resin

The obtained dispersion liquid for evaluation was mixed with methyl phenyl silicone in the same manner as in Example 1, and toluene was removed, thereby obtaining a composition. As a result of removing toluene, the obtained composition became white turbid and was turned into a gel.

(iv) Evaluation of Stability of Composition

Since the composition became white turbid and was turned into a gel, the viscosity was not measured.

(v) Production of LED Package

The composition that had become white turbid and been turned into a gel was obtained, and it was not possible to obtain a composition capable of sealing LEDs. Therefore, it was not possible to produce an LED package.

When the dispersion liquids of Comparative Example 1 and Example 1 were compared, since the zirconium oxide particles were dispersed in a high concentration of the surface-modifying material, in Example 1, the particle size distribution (D90/D50) of the dispersion liquid to be obtained was large and the dispersion liquid slightly deteriorated compared with Comparative Example 1. This is assumed to be because the dispersion liquid of Example 1 contained a large amount of the surface treatment material and thus had a viscosity in a high state and was under conditions where dispersion was difficult.

However, in the dispersion liquids according to Examples 1 and 2 in which the zirconium oxide particles were dispersed in a high concentration of the surface-modifying material, white turbidity was not caused in the highly hydrophobic resin, and it was possible to obtain transparent compositions. On the other hand, when the dispersion liquid according to Comparative Example 1 was mixed with a hydrophobic resin, the hydrophobic resin became white turbid, and it was not possible to obtain a transparent composition. These are surprising results that have been thus far unknown.

### INDUSTRIAL APPLICABILITY

A method for surface-modifying inorganic particles that is intended to obtain inorganic particles in which agglomeration is suppressed even when mixed with a highly hydrophobic material and the occurrence of turbidity such as white turbidity is prevented, a method for producing a dispersion liquid, and a dispersion liquid are provided.

1. A method for surface-modifying inorganic particles, comprising:
a mixing step of mixing at least a surface-modifying material and the inorganic particles to obtain a liquid mixture; and
a dispersion step of dispersing the inorganic particles in the liquid mixture,
wherein a content of the inorganic particles in the liquid mixture is 10% by mass or more and 49% by mass or less, and
a total content of the surface-modifying material and the inorganic particles in the liquid mixture is 65% by mass or more and 98% by mass or less.

2. The method for surface-modifying inorganic particles according to claim 1, further comprising:
a hydrolysis step of mixing at least the surface-modifying material and water before the mixing step to obtain a hydrolyzed liquid containing a hydrolyzed surface-modifying material,
wherein the mixing step is a step of mixing the hydrolyzed liquid containing the hydrolyzed surface-modifying material and the inorganic particles to obtain the liquid mixture.

3. The method for surface-modifying inorganic particles according to claim 2,
wherein an amount of water that is added to the hydrolyzed liquid is 0.5 mol or more and 5 mol or less with respect to 1 mol of the surface-modifying material.

4. A method for producing a dispersion liquid, comprising:
a mixing step of mixing a surface-modifying material and inorganic particles to obtain a liquid mixture; and
a dispersion step of dispersing the inorganic particles in the liquid mixture to obtain the dispersion liquid in which the inorganic particles are dispersed,
wherein a content of the inorganic particles in the liquid mixture is 10% by mass or more and 49% by mass or less, and a total content of the surface-modifying material and the inorganic particles in the liquid mixture is 65% by mass or more and 98% by mass or less.

5. A dispersion liquid comprising:
inorganic particles; and
one or more surface-modifying materials that are at least partially attached to the inorganic particles,
wherein a content of the inorganic particles is 10% by mass or more and 49% by mass or less, and
a total content of the surface-modifying material and the inorganic particles is 65% by mass or more and 98% by mass or less.

6. The dispersion liquid according to claim 5,
wherein, when a volume-based 90% particle diameter of the inorganic particles is represented by D90, and a volume-based 50% particle diameter of the inorganic particles is represented by D50, D90/D50 is 1.0 or more and 3.0 or less.

7. The dispersion liquid according to claim 5,
wherein an average primary particle diameter of the inorganic particles is 3 nm or more and 200 nm or less.

8. The dispersion liquid according to claim 6,
wherein an average primary particle diameter of the inorganic particles is 3 nm or more and 200 nm or less.
